(19) United States
(12) Patent Application Publication
(10) Pub. No.: US 2003/0199603 A1
(43) Pub. Date: Oct. 23, 2003

(54) Cured compositions transparent to ultraviolet radiation

(75) Inventors: Christopher B. Walker, St. Paul, MN (US); Dora M. Paolucci, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/116,778

(22) Filed: Apr. 4, 2002

(51) Int. Cl. C08G 2/00

(52) U.S. Cl. 522/99

(57) ABSTRACT

A curable coating composition that may be converted to a cured coating for an optical fiber during a continuous fiber coating process. The curable coating composition comprises an organohydrogenpolysiloxane, an alkenyl functional polysiloxane, and an ultraviolet radiation absorbing hydrosilation photocatalyst in an amount for crosslink formation between the organohydrogenpolysiloxane and the alkenyl functional polysiloxane. The curable coating composition crosslinks under the influence of ultraviolet radiation to provide a cured coating having a high level of transparency to ultraviolet radiation. Application of heat to the curable coating composition accelerates the rate of cured coating formation. The high level of transparency of the cured coating allows from about 70% to about 99% of radiation of wavelengths from about 240 nm to about 275 nm to pass through the coating for writing a refractive index grating to produce an optical fiber Bragg grating.

### FIELD OF THE INVENTION

The invention relates to photocurable compositions applied as protective coatings to optical waveguides. After curing, these coatings allow passage of actinic radiation used to modify optical waveguide transmission characteristics. More particularly the present invention provides coating compositions curable by absorption of ultraviolet radiation yet retaining transparency to ultraviolet radiation to allow change of underlying optical fiber waveguides to incorporate light modifying elements, such as Bragg gratings, into the waveguide structure.

### BACKGROUND OF THE INVENTION

Manufacturing processes for high purity glass optical fibers typically include in-line coating equipment to apply protective polymeric coatings to fibers drawn from a melt or solid preform. A glass fiber, as drawn, exhibits very high tensile strength. Flaws developing on the surface of a fiber cause substantial weakening. A protective coating, applied before contact of the fiber with either contaminants or solid surfaces, aids retention of inherent high strength as it protects the fiber.

A variety of protective coating systems have been used commercially to produce optical fibers for telecommunications applications. One known system applies protective polysiloxane polymers having sufficient stability to withstand elevated temperatures for prolonged periods of use. U.S. Pat. No. 4,765,713, U.S. Pat. No. 4,848,869, U.S. Pat. No. 4,877,306, and U.S. Pat. No. 4,962,996 provide examples of optical fibers including protective polysiloxane coatings. These products usually require elevated temperature curing for conversion to the protective polymer. In the case of U.S. Pat. No. 4,689,248, elevated temperature curing causes a cross-linking reaction between Si—CH=CH₂ and Si—H groups to form —Si—CH₂CH₂—Si— crosslinks. Key reactants require separation into two parts to be mixed together as required for coating optical fibers. Addition of a reaction inhibitor prevents premature crosslinking after mixing in the presence of a thermally activated hydrosilation catalyst. Coating compositions reportedly have satisfactory pot-life, exhibit acceptable physical properties after coating, and strip easily from the glass fiber.

Stripping or removal of protective coating from optical fibers is part of a process for modifying light transmission characteristics of optical fiber waveguides. Modification of light transmission characteristics allows a variety of special features to be included in selected, relatively short lengths of optical fibers to be spliced into fiber optic networks. A fiber Bragg grating represents a light-modifying feature that may be introduced or written into an optical fiber by exposure to ultraviolet light. Gratings may be written for a variety of applications including dispersion compensation, controlling the wavelength of laser light, and modifying the gain of optical fiber amplifiers.

Conventional processes for incorporating light modifying features into optical fibers require removal of coatings from manufactured optical fiber structures. The coatings typically attenuate passage of ultraviolet radiation. Exposure of coated optical fibers to high intensity ultraviolet radiation for through-coat variation of refractive index generally causes coating decomposition and deterioration of beam intensity reaching the optical fiber core.

A capability for through-coat refractive index variation of optical fibers would eliminate process steps for stripping coatings before modifying the fiber and applying recoat material after exposing the bare fiber to ultraviolet radiation. Elimination of process steps contributes to improvement in manufacturing costs and productivity.

Write-through coatings for optical fibers have been described for a variety of polymer types including fluorinated polymers and polysiloxane materials. Claesson et al (International Wire & Cable Symposium Proceedings 1997, Pages 82-85 (46^{th} Philadelphia, Pa.)) use two polymers to coat germanosilicate optical fibers prior to exposure to an ultraviolet radiation pattern to produce Bragg gratings in optical fibers so exposed through the polymer coatings. The coatings, applied by solvent dip or die draw, were TEFLON AF 1600 and KYNAR 7201. When thin (20-50 μm) films of KYNAR 7201 were exposed to a pulsed excimer pumped frequency doubled dye laser at a wavelength of 242 nm, the plastic rapidly degraded, darkened and decomposed.

No degradation was observed for films (6 μm) of TEFLON AF 1600 coated on boron codoped fibers during exposure to a pulsed excimer pumped frequency doubled dye-laser at 242 nm to write a Bragg grating (1 cm long) using an interferometric technique. The estimated fluency in the core per pulse was 1 J/cm² and the accumulated dose for writing the grating was 140 J/cm². Optical fibers were coated using relatively crude conditions including extended drying times as follows. After drying at room temperature for a few minutes, the solvent was removed in two steps by heating. For improved adhesion, the manufacturer recommends heating to 330° C. for 10-15 minutes and the use of a fluorosilane as an adhesion promoter.

Imamura et al (Electronics Letters, Vol. 34, No. 10, pp. 1016-1017) describes the preparation of a coated optical fiber and conditions used to expose the fiber to ultraviolet radiation during writing of a Bragg grating. The UV radiation source was a frequency quadrupled Q-switched YAG laser operating at 266 nm. This laser was capable of delivering a mean power of 100 mW at 10 Hz repetition with pulse duration of 50 ns. The description includes further detail of conditions used to form a Bragg grating.

The only information regarding the fiber coating material describes it as a UV curable resin formulated with a photoinitiator for increased transparency at 266 nm. Recommended conditions for forming a Bragg grating through a 60 μm coating of the resin include 10 minutes exposure at 150 J/cm². At this condition the UV absorbance at 266 nm wavelength was <1.07.

Chao et al (Electronics Letters, Vol. 35, No. 11 (May 27, 1999) and U.S. Pat. No. 6,240,224) discusses drawbacks of earlier attempts to write gratings through coatings over optical fibers before discussing the use of a thermally cured silicone coating (RTV 615). This material has suitable UV transparency since it contains no photoinitiator that would attenuate the intensity of a UV beam used to produce a Bragg grating. A UV spectrum reveals that a 150 μm thick layer of silicone between silica plates will transmit 85% of incident radiation at a wavelength of 225 nm. From 225 nm to 235 nm and above there is a gradual increase of radiation transmitted to 92%. This low UV absorption suggests the possibility of Bragg grating writing through the silicone rubber coating using either a frequency doubled Argon-ion laser at 244 nm or a KrF excimer laser at 248 nm.

Aspell et al (U.S. Pat. No. 5,620,495) describes formation of an optical fiber grating by writing through a methylsilsesquioxane coating. The description omits the process and conditions for applying the coating to the fiber.

Mayer et al (J. Polymer Sci., Part A: Polymer Chem.; Vol. 34, No. 15, p. 3141-3146 (1996)) presents findings from investigating trimethyl (β-dicarbonyl) Pt (IV) complexes as alternatively useful photocatalysts for the radiation-activated hydrosilation of silicone polymers.

General silicone compositions were given as Si—H/Si-vinyl (SiH:Vi) molar ratio of 1.7 of two commercial silicones RP1 and RP2 with catalyst added to obtain 250-300 ppm elemental platinum in the mixture. Films were deposited with a controlled thickness of 20-25 μm on a KBr crystal window and exposed to the filtered HPK125W (UV) light. Disappearance of the Si—H frequency was followed using IR spectroscopy. The paper gives no information of value to coating of optical fibers and Bragg grating formation. No radiation intensity (power) information was given. The irradiation source was a medium pressure UV lamp.

Previous studies described in U.S. Pat. No. 4,510,094, U.S. Pat. No. 4,530,879, U.S. Pat. No. 4,600,484, U.S. Pat. No. 4,916,169, U.S. Pat. No. 5,145,886, U.S. Pat. No. 6,046,250, EP 398,701, EP 561,893 and Mayer et al (J. Polymer Sci., Part A: Polymer Chem.; Vol. 34, No. 15, p. 3141-3146 (1996)) reveal the use of hydrosilation photocatalysts for curing silicone compositions containing vinyl and hydrosilyl functionality. There is nothing to suggest ready application of photocured silicone compositions as coatings having sufficient transparency to allow structural modification of an optical fiber using ultraviolet radiation to write a refractive index grating in the optical fiber.

Transparent coatings, as described above, are known as write-through coatings. Chao et al (Electronics Letters, Vol. 35, No. 11 (May 27, 1999) and U.S. Pat. No. 6,240,224) in fact recommend the use of thermally cured silicone coatings as candidate materials for write-through coatings. Application of thermally cured silicones to optical fibers retains maximum UV transparency by avoiding the use of compositional components that may absorb ultraviolet radiation. Absorption of radiation during periodic modification of the refractive index of an optical fiber interferes with formation of a refractive index grating in the fiber.

Claesson et al (International Wire & Cable Symposium Proceedings 1997, Pages 82-85 (46^{th} Philadelphia, Pa.)) describe the use of fluorinated polymers as write-through coatings. Imamura et al (Electronics Letters, Vol. 34, No. 10, pp. 1016-1017) discuss photocurable resins including photoinitiators having minimal absorption in a portion of the ultraviolet spectrum. These write-through resins were not identified. Other omissions from previous descriptions include the use of continuous processes for applying write-through coatings and the conditions and amount of time required to cure such coatings circumferentially around the fiber. Such omissions reinforce the need for improvement in coating compositions and methods for applying write-through coatings to optical fibers so as to improve the production rate for optical fiber refractive index gratings also referred to as Bragg gratings.

### SUMMARY OF THE INVENTION

The present invention satisfies the need for photocurable silicone compositions suitable for use in coating operations on optical fiber draw towers to provide coated, protected optical fibers that retain maximum strength characteristics by allowing changes to be made in the refractive index of an optical fiber without the conventional practice of removing the protective coating. Photocurable silicone compositions according to the present invention rely upon a curing reaction wherein a hydrosilation photocatalyst promotes crosslinking between vinyl and hydrosilyl groups pendant to the silicone backbone. Hydrosilation photocatalysts strongly absorb ultraviolet radiation. Selecting just enough catalyst for crosslinking minimizes the loss of coating transparency. A suitable range of catalyst concentrations provides silicone coating compositions that cure rapidly for tower application while retaining sufficient transparency to allow through-coating writing of optical fiber Bragg gratings using ultraviolet radiation of selected wavelengths.

A distinguishing feature of the present invention is the retention of transparency for sufficient time to form Bragg gratings having reflectivities ranging from about 2% to about 99% and bandwidths from about 0.1 nm to about 30 nm, as required for the formation of pump stabilization gratings, dense wavelength division multiplexing filters and dispersion compensation gratings. This discovery depends upon catalyst concentrations that promote in-tower crosslinking of coating compositions without raising UV absorption to a level that interferes with subsequent through-coat variation of the refractive index characteristics of the optical fiber.

Typical sources of high intensity ultraviolet radiation include continuous frequency doubled Argon-ion lasers operating at 244 nm and pulsed KrF excimer lasers generating pulses at 248 nm. The high dosage of ultraviolet radiation used to form optical fiber Bragg gratings eventually affects the write-through coating causing a relatively sudden decline in transparency to ultraviolet radiation. This rapid decline in transparency imposes a limit on the allowable rate of formation of the optical fiber Bragg grating.

Write-through coatings having a value of peak transmission of 80%, or more, are expected to allow optical fiber gratings to be written in approximately the same amount of time as gratings written in bare optical fiber. Conventional manufacturing procedures require adjustment of laser intensity to produce a desired refractive index grating within a range of exposure times from about 30 seconds to about two minutes. Higher reflectivity gratings require writing times of several minutes. Coatings according to the present invention retain sufficient transparency beyond the longest times normally used to produce Bragg gratings.

Photocurable compositions according to the present invention preferably contain a mixture or blend of fluid polysiloxane polymers substantially free from solvent. Compositions may be cured by formation of crosslinks between polymer chains via a hydrosilation reaction. This reaction requires a combination of polysiloxanes that includes polymers having vinyl functionality with polymers including hydrosilyl groups. Suitable classes of silicone polymer include vinyl terminated polydimethylsiloxanes, and methylhydrosiloxane-dimethylsiloxane copolymers.

Silicone compositions according to the present invention cure by crosslinking upon exposure to ultraviolet radiation in the presence of a hydrosilation photocatalyst. Preferred hydrosilation photocatalysts include organometallic complexes of palladium and platinum, particularly cyclopentadienyltrimethylplatinum and bisacetylacetonateplatinum.

More particularly the present invention provides a curable coating composition that may be converted to a cured coating for an optical fiber during a continuous fiber coating process. The curable coating composition comprises an organohydrogenpolysiloxane, an alkenyl functional polysiloxane, and an ultraviolet radiation absorbing hydrosilation photocatalyst in an amount for crosslink formation between the organohydrogenpolysiloxane and the alkenyl functional polysiloxane. The curable coating composition crosslinks under the influence of ultraviolet radiation to provide a cured coating having a high level of transparency to ultraviolet radiation. Application of heat to the curable coating composition accelerates the rate of cured coating formation. The high level of transparency of the cured coating allows from about 70% to about 99% of radiation of wavelengths from about 240 nm to about 275 nm to pass through.

A curable coating applied to an optical fiber provides a coated optical fiber. The coated optical fiber comprises an optical fiber and a curable coating composition comprising an organohydrogenpolysiloxane, an alkenyl functional polysiloxane and an ultraviolet radiation absorbing hydrosilation photocatalyst in an amount of from about 0.0003 wt % to about 0.15 wt % for crosslink formation between the organohydrogenpolysiloxane and the alkenyl functional polysiloxane. Exposure to ultraviolet radiation causes the curable coating composition to crosslink to provide a cured coating that allows from about 70% to about 99% of radiation of wavelengths from about 240 nm to about 275 nm to pass therethrough.

Passage of ultraviolet radiation through cured coatings according to the present invention allows writing of one or more refractive index gratings, or Bragg gratings, in the core of the underlying optical fiber. An optical fiber refractive index grating comprises an optical fiber having a cured coating of a curable coating composition on its surface. The curable coating composition comprises an organohydrogenpolysiloxane, an alkenyl functional polysiloxane, and an ultraviolet radiation absorbing hydrosilation photocatalyst in an amount of from about 0.0003 wt % to about 0.15 wt % for crosslink formation between the organohydrogenpolysiloxane and the alkenyl functional polysiloxane. Exposure to ultraviolet radiation causes the curable coating composition to crosslink to provide a cured coating that allows from about 70% to about 99% of radiation of wavelengths from about 240 nm to about 275 nm to pass therethrough. A refractive index grating or Bragg grating forms in the optical fiber during exposure to a pattern of ultraviolet radiation, passing through the cured coating, to produce periodic variations of refractive index in the optical fiber thereby providing the optical fiber refractive index grating.

The present invention provides a process for continuous production of a coated optical fiber. The process begins by providing a glass perform to be heated to a temperature to provide a melted portion of the glass perform. An optical fiber is drawn from the melted portion of the glass preform. The optical fiber moves into a position for applying a curable coating composition to the optical fiber. The curable coating composition comprises an organohydrogen-polysiloxane, an alkenyl functional polysiloxane, and an ultraviolet radiation absorbing hydrosilation photocatalyst in an amount of from about 0.0003 wt % to about 0.15 wt % for crosslink formation between the organohydrogenpolysiloxane and the alkenyl functional polysiloxane. Exposure of the curable coating composition to ultraviolet radiation, for about 0.2 sec to about 0.7 sec, provides the coated optical fiber having a cured coating that allows from about 70% to about 99% of radiation of wavelengths from about 240 nm to about 275 nm to pass therethrough. Heating the coated optical fiber at temperatures between about 350° C. and about 700° C., for about 1.0 sec to about 2.5 sec, increases the rate of cure of the curable coating composition.

Definitions

The following definitions clarify the meaning of terms used to describe the present invention.

The terms “photopolymerization” or “photocuring” or the like, as used herein, describe crosslinking of coating compositions that may optionally employ a free radical mechanism, or a cationic mechanism, based on the use of photoinitiator, or a catalyzed reaction involving a photocatalyst. Since the word catalyst is often loosely applied to initiation, the following definitions provide distinction between true catalysts and initiators.

The term “initiator” means an agent used to start the polymerization, usually of a monomer. Its action is similar to that of a catalyst, except that an initiator is usually consumed in the reaction, and a portion of the initiator becomes covalently bonded to the resulting polymer.

Terms such as “catalyst,” “photocatalyst” and “hydrosilation photocatalyst” refer to substances of which a small proportion notably affects the rate of a chemical reaction without the catalyst itself being consumed. Catalyst concentrations may be stated as wt %, which may be converted to parts per million (ppm) using a multiplier of 10⁴.

The term “photothermocurable” refers to coating compositions that cure by exposure to suitable actinic radiation optionally followed by heating for full crosslinking.

Coatings having transparency to ultraviolet radiation are referred to herein as “write-through” coatings that cure during exposure to suitable actinic radiation or heating or both.

The term “pass time” means the length of time that a “write-through” coating remains within 5% of its maximum for transmission of ultraviolet radiation.

The term “peak % transmission” describes the maximum amount of incident ultraviolet radiation that passes through a cured write-through coating according to the present invention.

The terms “refractive index grating” and “Bragg grating” and the like are equivalent and used interchangeably herein.

Unless stated otherwise concentrations of components are stated in terms of percent by weight (wt %) of solvent-free compositions.

### DETAILED DESCRIPTION OF THE INVENTION

The present invention provides a write-through coating as an optical fiber coating that exhibits transparency to ultraviolet radiation for enough time to alter the refractive index of an underlying optical fiber during exposure to high intensity ultraviolet radiation produced by e.g. a laser or a high power source of radiation. A transparent coating according to the present invention enables increases in manufacturing efficiency and production volumes of products, e.g. refractive index gratings or Bragg gratings, that include portions varying in refractive index. Suitable coating materials remain stable, maintaining high levels of transparency for high volume production of high quality fiber Bragg gratings.

Two-part thermal cure silicones are known as “write-through” coatings (see U.S. Pat. No. 6,240,224). In general a two-part silicone requires mixing a catalyst containing material with a material that cures under the influence of the catalyst. The curing reaction begins, even at room temperature, after addition of the thermal catalyst. An increase in viscosity occurs due to increasing molecular weight as the liquid mixture cures. This limits the useful coating time due to changing viscosity of materials and loss of consistency of optical fiber coating thickness from as low as 6 μm to a more typical range of about 30 μm to about 150 μm. Optimum conditions for optical fiber coating include the use of a coating composition of uniform viscosity over an extended time period. This is particularly true for application of coatings in an optical fiber draw tower where time is consumed during initial set-up and process stabilization. Two-part thermal cure silicone coatings may suffice for short-run coating of optical fibers but are unsuitable for extended coating runs associated with efficient manufacturing operations.

Coatings described herein contain a photocatalyst to postpone and control the onset of curing after application of polysiloxane fluid compositions to optical fibers. Delay of curing allows application of a consistent viscosity composition of uniform coating thickness on the fiber for the duration of the fiber draw. Exposure of the coated fiber to a source of ultraviolet radiation provides a suitable dose of energy to initiate a crosslinking reaction to cure the coating on the fiber. Heat may be applied to accelerate the curing reaction, particularly to promote crosslinking of coatings applied in a draw tower.

Photothermocurable fluid polysiloxane compositions according to the present invention comprise a substantially linear olefinic group containing polydiorganosiloxane, an organohydrogenpolysiloxane crosslinking agent and a hydrosilation photocatalyst provided as a complex compound of a noble metal such as platinum and palladium. The substantially linear olefinic group containing polydiorganosiloxane of the photocurable polysiloxane composition may be any polysiloxane polymer that contains the requisite olefinic groups. A preferred olefinic group containing polydiorganosiloxane includes alkenyl terminal groups and has the following general formula wherein the terminal alkenyl groups are preferably vinyl or allyl. Other alkenyl radicals include any aliphatic unsaturated radicals such as butenyl, hexenyl, octenyl, and pentenyl and the like that react with silicon-bonded hydrogen atoms

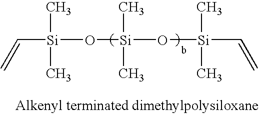

The length of the polymer chain depends upon the number of repeating units represented by the letter “b,” which corresponds to liquid polysiloxanes having a viscosity from about 10 centipoise to about 5,000,000 centipoise, preferably about 1000 centipoise to about 250,000 centipoise at 25° C.

Any organohydrogenpolysiloxane may be used as a crosslinking agent for photocurable compositions according to the present invention. Suitable materials contain at least three silicon-bonded hydrogen atoms per molecule. They may be selected from organohydrogenpolysiloxane homopolymers, copolymers and mixtures thereof, which may contain units selected from dimethylsiloxane units, methylhydrogensiloxane units, dimethylhydrogensiloxane units, trimethylsiloxane units and siloxy units. Some examples of organohydrogenpolysiloxanes include polymethylhydrogensiloxane cyclics, copolymers of trimethylsiloxy and methylhydrogensiloxy units, copolymers of dimethylhydrogensiloxy units and methylhydrogensiloxy units, copolymers of trimethylsiloxy, dimethylsiloxy and methylhydrogensiloxy units, and copolymers of dimethylhydrogensiloxy, dimethylsiloxy and methylhydrogensiloxy units.

Preferred organohydrogenpolysiloxanes include methylhydrogensiloxydimethylsiloxane copolymers, e.g. HMS 501 from Gelest Inc., Tullytown, Pa. and those present in SYLGARD 184 (a two-part silicone available from Dow Corning, Midland, Mich.) that was supplied free from the thermohydrosilation catalyst that the commercial version usually contains.

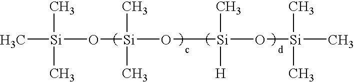

### HMS-501—Methylhydrogensiloxydimethylsiloxane copolymer

Polysiloxanes incorporating phenyl functionality into either vinyl-containing resins or silicon hydride-containing resins gave coatings that were dramatically less transparent to ultraviolet radiation than those discussed previously regardless of comonomers used to form polysiloxane copolymers. The following structure shows one example of an organohydrogenpolysiloxane (HDP-111-hydride terminated polyphenyl(dimethylhydrosiloxy) siloxane, available from Gelest Inc., Tullytown, Pa.) having phenyl functionality.

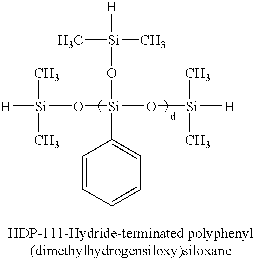

Coating formulations according to the present invention included varying ratios of alkenyl-terminated polydimethylsiloxanes and hydride-containing polysiloxane crosslinkers. Preferred compositions contain an amount of organohydrogenpolysiloxane sufficient to provide from about 0.1 to about 10 silicon-bonded hydrogen atoms per alkenyl radical to produce coatings of desired transparency.

Photocatalysts suitable for curing polysiloxane compositions according to the present invention include catalysts effective in initiating or promoting a hydrosilation cure reaction. Such a catalyst is referred to herein as a noble or precious metal photocatalyst or a hydrosilation photocatalyst. Suitable precious metal photocatalysts include any complex compounds of platinum and palladium that cure polysiloxane compositions to films that retain a high level of transparency. Materials of this type include (η⁵-cyclopentadienyl)trialkylplatinum complexes as described in U.S. Pat. No. 4,510,094, (η-diolefin)(σ-aryl)platinum complexes similar to those in U.S. Pat. No. 4,530,879 and β-diketone complexes of palladium (II) or platinum (II), such as platinum acetyl acetonate (U.S. Pat. No. 5,145,886). Preferred precious metal hydrosilation photocatalysts include bis-acetylacetonate platinum (II) [Pt(AcAc)₂] and (η⁵-cyclopentadienyl)trimethylplatinum [Pt CpMe₃]. These hydrosilation photocatalysts when included in photocurable polysiloxane compositions at concentrations between about 3 ppm and about 1500 ppm cured satisfactorily as coatings on quartz slides. Preferred concentration of precious metal hydrosilation photocatalysts for in-tower curing and retention of transparency to ultraviolet radiation is from about 50 ppm to about 200 ppm, which concentrations remarkably cure coatings applied to optical fibers in the few seconds available during the in-tower optical fiber draw process. A similar concentration of a palladium complex hydrosilation photocatalyst cures a polysiloxane composition to a highly transparent film. The rate of curing using a palladium containing photocatalyst was significantly lower than related complex platinum photocatalysts previously described. While retaining desirable transparency, films formed with palladium photocatalysts do not meet curing requirements for coatings applied in a draw tower environment.

Polysiloxane compositions cured in the presence of hydrosilation photocatalysts, compared to cure initiation of coating compositions by cationic, free radical, and free radical variation mechanisms, show a distinct advantage of the polysiloxane compositions for producing cured films transparent to ultraviolet radiation. Only films cured by using precious metal hydrosilation photocatalysts maintained a high level of transparency, corresponding to transmission of about 70% to about 99% of incident radiation at wavelengths from about 240 nm to about 275 nm, for protracted exposure to the high intensity beam of an ultraviolet laser. Evaluation of transmission of ultraviolet radiation with time, for cured films according to the present invention, showed an interesting change in transparency. Instead of a gradual attenuation of transmitted intensity of radiation, the cured films displayed a surprisingly high, constant transmissivity for a period of time before an abrupt loss in transmission occurred. Results from film transparency evaluations predicted the polysiloxane compositions that would be sufficiently transmissive to ultraviolet radiation, after curing with a hydrosilation photocatalyst, to permit change in the refractive index properties of an optical fiber protected by the cured polysiloxane film. Films meeting or exceeding performance requirements are referred to herein as “write-through” coatings since they allow through-coating formation or writing of e.g. Bragg gratings using conventional methods to introduce periodic variation of refractive index along a selected length of an optical fiber.

Preferably, the present invention uses unfilled coating compositions. Other additives, including reinforcing agents and flow control agents, may be used provided they do not interfere with coating transparency.

Experimental

Materials

Polysiloxane resins were employed, in which crosslinking was effected through different polymerization mechanisms. Some resins were obtained from a supplier as previously formulated coatings, containing a photoinitiator. This eliminates the need to add a photoinitiator prior to curing the coating on an optical fiber using UV irradiation.

Resins

R1 Q3-6696 is a UV curable polysiloxane coating for optical fibers that is commercially available from Dow Corning, Midland, Mich.

R2 OF-206 is an optical fiber coating commercially available from Shin-Etsu, Tokyo, Japan, as a phenyl group containing UV curable polysiloxane that cures by a free radical mechanism

R3 GP-554 is an glycidyl epoxy functional dimethylpolysiloxane available from Genesee Polymers (Flint, Mich.).

R4 Modified SYLGARD 184 is a two part polysiloxane resin omitting the standard Dow Corning thermal hydrosilation catalyst. Part A is believed to contain a dimethylvinyl-terminated polydimethylsiloxane, a mixture of dimethylvinylated and trimethylated silica and tetra(trimethylsiloxy)silane. The composition of part B is believed to include a methylhydrogen polydimethylsiloxane, a dimethylvinyl-terminated polydimethyl siloxane, and a mixture of dimethylvinylated and trimethylated silica. The recommended ratio Part A:Part B is 10:1.

R5-R9 appear in Table 1.

TABLE 1
R5-R9 Resin Compositions (wt %)

| Resin | DMS-V31 | DMS-V35 | HMS-501 | HDP-111 |
|---|---|---|---|---|
| R5 | | 98.66 | | 1.34 |
| R6 | 88.78 | | 11.22 | |
| R7 | 94.05 | | 5.94 | |
| R8 | 96.93 | | 3.07 | |
| R9 | 98.75 | | 1.25 | |

*Key to resin components (all available from Gelest Inc., Tullytown, Pa.):

DMS-V00, -V31, -V35 and -V52, are vinyl-terminated polydimethylsiloxanes.

HMS-501is a methylhydrosiloxane-dimethylsiloxane copolymer.

HDP-111 is a hydride-terminated polyphenyl(dimethylhydrogensiloxy)siloxane.

R10-R12

Table 2 includes solvent-free compositions for resins R10-R12, each prepared according to a general method in which a methylhydrosiloxane-dimethylsiloxane copolymer mixed with a vinyl terminated polydimethylsiloxane was added to a vinylfunctional methylsilsesquioxane resin that was a 70% solution in xylene. The compositions were mixed until homogeneous before removal of the xylene using a rotary evaporator (RE 51—Yamato Scientific Co., Japan).

TABLE 2
R10-R12 Resin Compositions (wt %)

| Resin | R10 | R11 | R12 |
|---|---|---|---|
| HMS-501 | 9.73 | 13.42 | 8.39 |
| DMS-V31 | 63.47 | | 59.33 |
| DMS-V52 | | 21.88 | |
| DMS-V00 | | 21.88 | |
| MQ | 26.8 | 42.82 | 32.27 |
| Vi:Vi | 70:30 | — | 72:28 |
| SiH:Vi | 2:1 | — | 2:1 |

Note:
MQ copolymer resins comprise “M” groups (R₃SiO_{0.5}) and “Q” groups (SiO_{4/2}). In this case, MQ is used to identify a Dow Corning vinylfunctional MQ resin.

The ratio Vi:Vi refers to the weight ratio DMS-V31:Vinyl MQ.

The ratio SiH:Vi refers to the proportion of silicon hydride to vinyl groups.

### Photoinitiators

A IRGACURE 184 (1-Hydroxycyclohexylphenyl-ketone, Ciba-Geigy, Tarry Town, N.Y.) and IRGACURE 651 (2,2-dimethxy-2-phenylacetophenone, Ciba-Geigy, Tarry Town, N.Y.) are examples of free radical photoinitiators that are strongly UV absorbing.

B Cationic, UV absorbing photoinitiator is a solution of a 40:60:4 weight ratio mixture of bisdodecyl iodonium hexafluoroantimonate, a mixture of C10-C12 alcohols, and isopropylthioxanthone (a known sensitizer).

C Benzophenone—Catalog #23,985-2-Sigma-Aldrich (Milwaukee, Wis.).

D T-butylperoxybenzoate—Catalog #15,904-2-Sigma-Aldrich (Milwaukee, Wis.).

### Hydrosilation Photocatalysts

Photocatalysts E, F, G and H were synthesized as described in U.S. Pat. No. 4,510,094 and U.S. Pat. No. 4,530,879 (structures below) and are strongly UV absorbing. COD represents a cyclooctadienyl ligand.

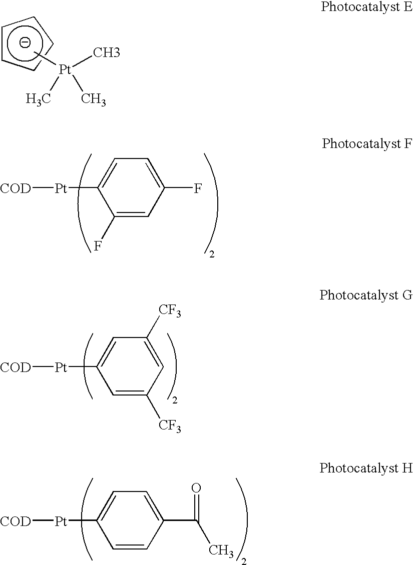

Photocatalyst J is designated Catalog #AKP 6000 from Gelest, Inc (Tullytown, Pa.).

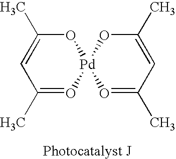

Photocatalyst K is designated Catalog #28,278-2 from Sigma-Aldrich (Milwaukee, Wis.).

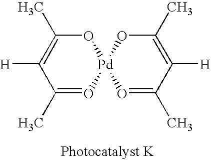

Table 3 includes Examples 1-10 according to the present invention using the two part polysiloxane resin R4 with various hydrosilation photocatalysts.

TABLE 3
Write-Through Coating Compositions-Examples 1-10 (wt %)

| | 1 | 2 | 3 | 4 | 5 | 6 | 7 | 8 | 9 | 10 |
|---|---|---|---|---|---|---|---|---|---|---|
| R4-A | 90.91 | 90.91 | 90.90 | 90.91 | 90.91 | 90.91 | 90.91 | 90.91 | 90.90 | 90.78 |
| R4-B | 9.08 | 9.08 | 9.08 | 9.08 | 9.08 | 9.08 | 9.08 | 9.08 | 9.08 | 9.07 |
| E | 0.005 | 0.01 | 0.02 | | | | | | | |
| F | | | | 0.01 | | | | | | |
| G | | | | | 0.01 | | | | | |
| H | | | | | | 0.01 | | | | |
| J | | | | | | | 0.01 | | | |
| K | | | | | | | | 0.0003 | 0.02 | 0.15 |
| SiH:Vi | 1.45 | 1.45 | 1.45 | 1.45 | 1.45 | 1.45 | 1.45 | 1.45 | 1.45 | 1.45 |

Table 4 provides compositions for Examples 11-16 according to the present invention using resins and photocatalysts identified previously.

TABLE 4
Write-Through Coating Compositions-Examples 11-16 (wt %)

| | 11 | 12 | 13 | 14 | 15 | 16 |
|---|---|---|---|---|---|---|
| DMS V31 | 88.8 | 94.07 | 96.89 | 98.71 | 63.47 | |
| DMS V52 | | | | | | 21.88 |
| DMS V00 | | | | | | 21.88 |
| HMS 501 | 11.2 | 5.94 | 3.10 | 1.28 | 9.73 | 13.42 |
| MQ | | | | | 26.79 | 42.82 |
| E | 0.01 | 0.01 | 0.01 | 0.01 | | 0.02 |
| K | | | | | 0.01 | |
| SiH:Vi | 10.5 | 5.3 | 2.6 | 1.1 | 2.2 | 0.36 |

Table 5 provides compositions for Comparative Examples C1-C5, of which C4A-C4E do not fully cure.

TABLE 5
Coating Compositions-Comparative Examples C1-C4E (wt %)

| | C1 | C2 | C3A | C3B | C4A | C4B | C4C | C4D | C4E |
|---|---|---|---|---|---|---|---|---|---|
| R1 | 100 | | | | | | | | |
| R2 | | 100 | | | | | | | |
| R3 | | | 99.8 | 99.6 | | | | | |
| R4A | | | | | 87.27 | 89.0 | 90.0 | 90.4 | 90.91 |
| R4B | | | | | 8.73 | 8.9 | 9.0 | 9.0 | 9.08 |
| B | | | 0.2 | 0.4 | | | | | |
| C | | | | | 4.0 | 2.0 | 1.0 | 0.5 | 0.01 |

Coating Compositions-Comparative Example C4F-C5 (wt %)

| | C4F | C4G | C4H | C4I | C4J | C5 |
|---|---|---|---|---|---|---|
| R1 | | | | | | |
| R2 | | | | | | |
| R3 | | | | | | |
| R4A | 87.27 | 89.0 | 90.0 | 90.4 | 90.91 | |
| R4B | 8.73 | 8.9 | 9.0 | 9.0 | 9.08 | |
| R5 | | | | | | 99.99 |
| D | 4.0 | 2.0 | 1.0 | 0.5 | 0.01 | |
| E | | | | | | 0.01 |

Film Preparation Equipment

While comparative examples and examples according to the present invention all require UV irradiation for curing, they polymerize by different mechanisms. Free radical mechanisms require a nitrogen atmosphere, to avoid oxygen inhibition of curing. Curing by cationic and hydrosilation catalysts proceeds in the presence of oxygen, but requires heat to fully cure reactive compositions. Coating schemes M1-M6 include suitable methods to produce cured coatings using compositions that cure by different mechanisms.

Coating Equipment

a) A bar coater was used to provide a film 100 μm thick on a quartz slide.

b) A spincaster (CB15 from Headway Research Inc., Garland, Tex.) was used with a Model PMW 32 controller to apply a film 100 μm thick on a quartz slide.

c) A film 100 μm thick was formed between quartz slides separated by a spacer.

d) A knife coater was used to provide a film 50 μm thick on a quartz slide

Ultraviolet Radiation Equipment

i) The exposure unit was a Fusion Systems MC6RQN moving belt processor using a H⁺ lamp (Model I-6; Part #SC60734SYS), approximately 7.5 cm from the processor belt, to provide a dose of ultraviolet radiation measured using a UV POWERPUCK™ radiometer.

ii) A Kaspar System 3001 UV curing station (Eaton Semiconductor Equipment) provided exposures of adjustable intensity using a control system MODEL 764 of Optical Associates Inc.

Method M1 used coating equipment a) and radiation equipment i) executing two passes at a belt speed of 25 ft/min.

Method M2 used coating equipment b) and radiation equipment ii) operating at an intensity of 14 mW/cm² for three minutes, followed by post-curing for twenty minutes in an oven controlled to a temperature of 125° C.

Method M3 used coating equipment a) and radiation equipment i) executing twenty passes under nitrogen at a belt speed of 25 ft/min. An attempt to drive the polymerization reaction involved post-curing samples for 17 hours in an oven held at 120° C.

Method M4 used coating equipment c) and radiation equipment i) executing ten passes at a belt speed of 50 ft/min. These samples were then post-cured at 120° C. for 17 hours.

Method M5 used coating equipment b) and radiation equipment ii) operating at an intensity of 14 mW/cm² for three minutes, followed by post-curing for twenty minutes in an oven controlled to a temperature of 125° C. An attempt was made to finish curing the composition by further heating the quartz slides at 120° C. for 34 hours.

Method M6 used coating equipment d) and radiation equipment i) executing four passes at a belt speed of 50 ft/min. The samples were then heated for 50 minutes in an oven controlled at 90° C.

### Film Preparation Summary Tables

Tables 6 and 7 summarize the comparative examples and film examples according to the present invention prepared using the formulations and the methods described above.

TABLE 6
Comparative Examples Film Preparation Summary

| Comparative | | Initiator/ | Cure | Film |
|---|---|---|---|---|
| Example | Resin | catalyst | Method | Thickness |
| C1 | R1 | A | M1 | 100 μm |
| C2 | R2 | A | M1 | 100 μm |
| C3A | R3 | B | M2 | 100 μm |
| C3B | R4 | B | M2 | 100 μm |
| C4A | R4 | C | — | 100 μm |
| C4B | R4 | C | — | 100 μm |
| C4C | R4 | C | M3 | 100 μm |
| C4D | R4 | C | M3 | 100 μm |
| C4E | R4 | C | M3 | 100 μm |
| C4F | R4 | D | M4 | 100 μm |
| C4G | R4 | D | M4 | 100 μm |
| C4H | R4 | D | M4 | 100 μm |
| C4I | R4 | D | M4 | 100 μm |
| C4J | R4 | D | M4 | 100 μm |
| C5 | R5 | E | M4 | 100 μm |

Note: Comparative Example C4A-J were attempts to utilize photoinitiators taught as capable of reacting vinyl groups with silicon-hydride groups in the following patents: U.S. Pat. No. 4,608,312; U.S. Pat. No. 4,558,147; U.S. Pat. No. 4,684,670; U.S. Pat. No.4,435,259; and U.S. Pat. No. 4,064,027. With the concentrations and methods summarized in the table above, Comparative Examples C4C-C4J did not readily polymerize to the expected rubbery films, yielding instead unacceptable gel-like polymers or liquids. Comparative Examples C4A and C4B were not tested because the photoinitiator did not dissolve completely in the coating composition.

TABLE 7
Examples Film Preparation Summary

| | | Initiator/ | Cure | Film |
|---|---|---|---|---|
| Example | Resin | catalyst | Method | Thickness |
| 1 | R4 | E | M2 | 50 μm |
| 2 | R4 | E | M2 | 100 μm |
| 3 | R4 | E | M6 | 50 μm |
| 4 | R4 | F | M2 | 100 μm |
| 5 | R4 | G | M2 | 100 μm |
| 6 | R4 | H | M2 | 100 μm |
| 7 | R4 | J | M5 | 100 μm |
| 8 | R4 | E | M2 | 50 μm |
| 9 | R4 | K | M6 | 50 μm |
| 10 | R4 | K | M2 | 50 μm |
| 11 | R6 | E | M2 | 50 μm |
| 12 | R7 | E | M2 | 50 μm |
| 13 | R8 | E | M2 | 50 μm |
| 14 | R9 | E | M2 | 50 μm |
| 15 | R10 | K | M6 | 50 μm |
| 16 | R11 | E | M6 | 50 μm |

Laser Testing

Film samples, prepared as described above, were subjected to high intensity ultraviolet radiation from an ultraviolet laser. The amount of radiation passing through a coating was measured in terms of percent transmission as a function of time. Studies were conducted using a continuous wave, frequency-doubled, argon-ion laser (Coherent Sabre:FreD), generating various beam intensity levels at 244 nm. The intensity level was controlled by the ratio of incident power to laser spot size. The effective intensity (W/cm²) for the testing is computed as

I_{eff}=Pi/(4π*w₁*w₂)

Pᵢ is the incident power

w₁ and w₂ are the 1/e² beam radii of the Gaussian intensity profile.

The effective intensity (I_{eff}) multiplied by the exposure time provides a value corresponding to the total dose of ultraviolet radiation (i.e., J/cm²) For comparison, the peak on-axis intensity (W/cm²) is calculated I(0)=2*Pᵢ/(π*w₁*w₂). A Molectron PM10 power probe and EPM1500 meter, connected via GPIB interface to a computer collected data to measure the amount of power transmitted (P_{T}). Transmission values expressed as a percentage were calculated as P_{T}/Pᵢ, with no correction made for loss due to reflection from the quartz slide (typically a few percent per glass/air interface).

Laser Testing Results

Known Bragg gratings vary in type depending on processing conditions. Process variation considers several factors including the total dose of ultraviolet radiation associated with each grating, the type of laser, the type of fiber, and any photosensitization method used to enhance the fiber response. Radiation doses range from 100's of Joules per cm², for low reflectivity or rapidly scanned gratings, to >10 kJ/cm², for highly reflective gratings fabricated in fibers with limited photosensitivity. Low intensity exposures are effective for writing low reflectivity gratings.

Slide testing of UV transparent coatings shows that a greater total dose (intensity multiplied by time) of ultraviolet radiation passes through a film at lower exposure source intensities. Successful high intensity testing of materials indicates similar or better performance at lower intensities.

Tables 8, 9, and 10 include laser-screening results for coatings described herein. “Peak percent transmission” gives the maximum transmission recorded, usually very close to the beginning of the experiment. A preferred value of peak transmission of 80%, or more, was selected for “write-through” coatings that were expected to allow gratings to form at speeds comparable with gratings written in bare fiber. Percent transmission values for some coatings did not drop below the passing level for the extent of the test. In such cases the value of total dose of radiation includes a “>” sign showing that the sample maintained a high transmission level exceeding the time allowed for the test. Retention times for transparency of examples of the invention typically exceed production times in which the laser intensity is adjusted to give a write time between 30 seconds and 2 minutes. High reflectivity gratings or relatively non-photosensitive fibers, require write times of several minutes. For this reason the “pass” time criteria exceed anticipated grating writing conditions.

“Pass time” is the length of time that the sample remained within 5% of the maximum transmission. The total dose is calculated by multiplying the pass time by beam intensity. Samples showing consistent transmission properties in the screening test typically maintain the observed consistency during the writing of Bragg gratings. Relatively rapid loss of transmission of ultraviolet radiation during screening tests indicates difficulties with writing gratings over extended periods of time.

TABLE 8
Laser Testing Of Previous Examples At 100 W/cm²

| | | | Total dose |
|---|---|---|---|
| Example | Peak % T | Pass time | (kJ/cm2) |
| 1 | 85% | >306 sec | >30 |
| 2 | 82% | >636 sec | >63 |
| 3 | 96% | >539 sec | >50 |
| 4 | 82% | >609 sec | >61 |
| 5 | 83% | >585 sec | >58 |
| 6 | 83% | >621 sec | >62 |
| 7 | 88% | >603 sec | >60 |
| 8 | 82% | >609 sec | >60 |
| 9 | 96% | >539 sec | >50 |
| 10 | 72% | >303 sec | >30 |
| 11 | 85% | >657 sec | >65 |
| 12 | 85% | >633 sec | >63 |
| 13 | 85% | >633 sec | >63 |
| 14 | 85% | >615 sec | >61 |
| 15 | 85% | >505 sec | >50 |
| 16 | 84% | >465 sec | >46 |

Coatings of Examples 2, and 4-7 (the 100 μm thick films), tested at 100 W/cm², exhibited at least the target level (80%) transmission of ultraviolet radiation for a time in excess of 9 minutes. This indicates sufficient transparency to permit grating writing. Since each of Examples 2 and 4-7 used 100 ppm of a different hydrosilation photocatalyst, it is apparent that several ultraviolet radiation-absorbing catalysts may be used to cure optical fiber coatings. It is surprising that the level of catalyst absorption does not markedly decrease coating transparency, but allows passage of more than enough power from Bragg grating writing lasers to write effective gratings in target fibers.

Examples 1, 3, and 8-16 (films 50 μm thick) tested at 100 W/cm², all met the target passing value after greater than 5 minutes exposure to ultraviolet radiation. This, once again, indicates sufficient transparency to permit grating writing. Even use of an excess of photocatalyst (1500 ppm) as in Example 10 gave remarkable retention of transparency during exposure to radiation of 100 W/cm² for more than 5 minutes.

Examples 11-14 demonstrate that resins consisting of vinyl functional silicones and silicon hydride-dimethylsiloxane copolymers in different ratios of vinyl to hydrosilyl groups are acceptable as write-through resins. Examples 15 and 16 show that the negative effect of increasing amounts of reinforcing/toughening agents such as the vinyl MQ resins does not become apparent until exposure of these coatings to high levels (i.e., 600 W/cm², Table 9) of ultraviolet radiation. Comparison of pass times (Table 9) shows that Example 15 remains at its highest transparency level twice as long as Example 16.

TABLE 9
Laser Testing Of Examples At 600 W/cm²

| | Peak % | | Total dose |
|---|---|---|---|
| Example | T | Pass time | (kJ/cm²) |
| 1 | 83% | >486 sec | >290 |
| 2 | 83% | 360 sec | 216 |
| 3 | 96% | 490 sec | 294 |
| 4 | 83% | 180 sec | 108 |
| 5 | 88% | >585 sec | >350 |
| 6 | 87% | 570 sec | 342 |
| 7 | 88% | >603 sec | >360 |
| 8 | 87% | >585 sec | >350 |
| 8 (@ 800 W/cm²) | 87% | 153 sec | 122 |
| 9 | 95% | 507 sec | 304 |
| 10 | 71% | 60 sec | 36 |
| 11 | 85% | >612 sec | >360 |
| 12 | 85% | >618 sec | >360 |
| 13 | 86% | >618 sec | >360 |
| 14 | 85% | 576 sec | 346 |
| 15 | 91% | 377 sec | 226 |
| 16 | 85% | 173 sec | 104 |

In the group of Examples 2, and 4-7 (the 100 μm thick films) tested at 600 W/cm², all of the Examples passed for 3 minutes or greater, indicating sufficient transparency to permit grating writing. Of the samples retaining high % transmission, Example 2 is preferred in a side-by-side comparison of the 100 μm thick samples having 100 ppm of the photocatalysts.

In the group of Examples 1, 3 and 8-16 (the 50 μm thick films) tested at 600 W/cm², many of the Examples passed for 7 minutes or more. Example 10 (at 600 W/cm²) showed the shortest passing time (60 seconds) which is appropriate for the writing of many gratings, but Example 3 is preferred for faster curing.

The comparative examples show low peak % transmission and maintain their peak transmissions for short durations, even at quite low intensities for some samples. The comparative examples include the samples cured by the radical photoinitiators and the cationic photoinitiators, as well as a sample (C5) of a photocatalyzed hydrosilation cured silicone, in which the silicone resin was highly absorbing owing to the presence of phenyl functionality. Table 10 summarizes the results for the comparative examples.

TABLE 10
Laser Testing Of Comparative Examples At Various Intensities

| Comparative | | | Intensity |
|---|---|---|---|
| Example | Pk % T | Pass time | (W/cm²) |
| C1 | 0% | 0 sec | 100 |
| C1 | 0% | 0 sec | 600 |
| C2 | 0% | 0 sec | 100 |
| C2 | 0% | 0 sec | 600 |
| C3A | 17% | 15 sec | 30 |
| C3B | 32% | 9 sec | 30 |
| C5 | 42% | 6 sec | 4 |
| C5 | 25% | 17 sec | 14 |

Fiber Draw Process

TABLE 11
Draw Tower Application Of Write-Through Coatings

| | Coating | Coating | Hydrosilation | Catalyst |
|---|---|---|---|---|
| Example | thickness | resin | photocatalyst | concentration |
| 2 | 30 μm | R4 | E | 100 ppm |
| 2 | 50 μm | R4 | E | 100 ppm |
| 3 | 30 μm | R4 | E | 200 ppm |
| 3 | 30 μm | R4 | E | 200 ppm |
| 3 | 30 μm | R4 | E | 200 ppm |

Coatings were processed by application to optical fibers immediately following fiber drawing in a draw tower. Equipment used in the draw process includes a Nokia-Maillefer fiber draw tower manufactured by the Nokia Corporation of Vantaa, Finland. The fiber optic drawing process uses a downfeed system to control the rate at which a highly photosensitive, boron and germanium co-doped optical pre-form and cladding enters the heating zone of a 15 KW Lepel Zirconia induction furnace, manufactured by Lepel Corporation of Maspeth, N.Y. In the heating zone temperatures reach from about 2200° C. to about 2250° C. Within this temperature range an optical pre-form may be drawn to an optical fiber. A LaserMike™ laser telemetric measurement system monitors the diameter of the optical fiber and its position in the draw tower.

The newly formed optical fiber passes to a primary coating station for application of a UV curable polysiloxane coating according to the present invention. Coating equipment preferably includes a coating die assembly. The coating die assembly includes a sizing die, a back pressure die, and a containment housing mounted on a stage having adjustment for pitch and tilt and x-y translation for control of coating concentricity. Application of coating thickness from about 15 μm to about 60 μm requires selection of a suitable die having an appropriate diameter compared to the 125 μm diameter of a typical glass fiber. The UV curable silicone material, supplied to the coating die assembly from a pressurized container, forms a coated layer for curing preferably using a 10 in. H⁺ UV lamp (available from Fusion Systems of Rockville, Md.) at 80% power, i.e.750W/cm (300 W/in). The UV source emits radiation in a range of wavelengths from about 245 nm to about 365 nm. Duration of exposure to ultraviolet radiation depends on the draw speed of the optical fiber and is typically less than about one second. Drawing and coating of optical fibers proceeds at a controlled rate, from about 25 m/min. to 60 m/min. Coating exposure times vary from about 0.6 seconds to about 0.25 seconds to apply coatings varying in thickness from about 0.6 μm to about 50 μm.

A concentricity monitor and a laser telemetric system measure the characteristics of the coating within the primary coating station. Full curing of an optical fiber coating requires initial exposure to UV radiation followed by high temperature curing in two sequential thermal zones, 20 inches in length, both set at 480° C. Heating times vary from about 2.4 seconds at about 25 m/min. to about 1.0 second at about 60 m/min. Thermal zone temperatures may be adjusted between about 350° C. and 700° C., preferably between about 450° C. and 500° C., depending upon required processing conditions. Following coating and ultraviolet and thermal curing, the completed optical fiber element is drawn through a control capstan onto a take-up spool.

Grating Examples

The high percent transmission of ultraviolet radiation for coating materials according to the present invention allows development of large index of refraction modulations in optical fiber of suitable photosensitivity. Although materials screening was conducted primarily using a continuous-wave laser, use of an excimer laser should be feasible. Table 12 includes characteristics of gratings written into optical fibers by ultraviolet radiation passing through UV cured polysiloxane coatings coated in a draw tower as described previously. Pump stabilization gratings (PS) typically have a reflectivity of 10% or less. Some PS gratings formed using Example 2, (Table 12) have higher reflectivity. This demonstrates more than adequate retention of transparency of write-through coatings, which allows highly reflective gratings to be written in 30 seconds to two minutes, using a continuous wavelength laser at beam intensities up to 500 W/cm2, in optical fibers having relatively low photosensitivity. Dispersion compensation gratings may be written in less than 0.25 second using a continuous wavelength laser having a beam intensity greater than about 1 kW/cm². Dense wavelength division multiplexing filters (DWDM) typically form in optical fibers during exposure to a high intensity continuous wave (cw) laser beam having a peak intensity of about 1 kW/cm² for less than 10 seconds.

TABLE 12
Gratings Written Through UV-Cure Silicone Coatings

| | | | | Grafting | |
|---|---|---|---|---|---|
| Example | Laser | Intensity | Time | Type | Reflectivity |
| 2 | cw | 50 W/cm² | 50 sec | PS* | 50% |
| 2 | cw | 45 W/cm² | 3 min | PS* | 70% |
| 2 | cw | 45 W/cm² | 4 min | PS* | 12% |
| 3 | Excimer | 100 mJ/cm² | 5 min | PS* | 5% |
| | | (5 W/cm²) | | | |
| 3 | cw | 45 W/cm² | 3 min | PS* | 55% |
| 3 | cw | 45 W/cm² | 3 min | PS* | 60% |
| 3 | Excimer | 67 mJ/cm² | <2 min | Filter | >99% |
| | | (3 W/cm2) | | | |
| 3 | cw | 9 W/cm² | 10 min | Filter | >99% |
| | | Chopping at | | | |
| | | 50 Hz | | | |

*PS refers to a “Pump Stabilization” grating.

As required, details of the present invention are disclosed herein; however, it is to be understood that the disclosed embodiments are merely exemplary of polysiloxane coatings preferably cured using a Pt containing hydrosilation photocatalyst to facilitate fiber coating under draw tower conditions. Coatings applied in this way have exhibited substantial transmission during exposure to radiation from ultraviolet lasers operating at fluences typically employed for writing gratings in bare fiber. Through-coating transmission of ultraviolet radiation is high and persistent to allow time to write a grating. Contrary to previous practice a grating forms in an optical fiber without removing protective coatings, specifically coatings according to the present invention.

Structural and functional details disclosed herein for write-through coatings applied to optical fibers are not to be interpreted as limiting, but merely as a basis for the claims and as a representative basis for teaching one skilled in the art to variously employ the present invention.

What is claimed is:

1. A curable coating composition comprising:
an organohydrogenpolysiloxane;
an alkenyl functional polysiloxane; and
an ultraviolet radiation absorbing hydrosilation photocatalyst in an amount for crosslink formation between said organohydrogenpolysiloxane and said alkenyl functional polysiloxane, said curable coating composition crosslinking under the influence of ultraviolet radiation for providing a cured coating having a high level of transparency to ultraviolet radiation.

2. The curable composition of claim 1, wherein said curable coating composition crosslinks under the influence ultraviolet radiation and heat to provide said cured coating.

3. The curable composition of claim 1, wherein said organohydrogenpolysiloxane is selected from organohydrogenpolysiloxane homopolymers, copolymers and mixtures thereof,

4. The curable composition of claim 1, wherein said alkenyl functional polysiloxane is a substantially linear polydiorganosiloxane having alkenyl groups selected from the group consisting of vinyl groups, allyl groups, butenyl groups, hexenyl groups, octenyl groups, and pentenyl groups and mixtures thereof.

5. The curable composition of claim 1, wherein said hydrosilation photocatalyst is a complex compound containing a noble metal.

6. The curable composition of claim 5, wherein said noble metal is selected from the group consisting of palladium and platinum.

7. The curable composition of claim 6, wherein said complex compound is selected from the group consisting of (η⁵-cyclopentadienyl)trialkylplatinum complexes, (η-diolefin)(σ-aryl) platinum complexes, β-diketone platinum complexes and β-diketone palladium complexes.

8. The curable composition of claim 7, wherein said complex compound is selected from the group consisting of bis-acetylacetonate platinum (II) and (η⁵-cyclopentadienyl)trimethyl platinum.

9. The curable composition of claim 1, wherein said hydrosilation photocatalyst has a concentration from about 0.0003 wt % to about 0.15 wt %.

10. The curable composition of claim 1, wherein said high level of transparency allows from about 70% to about 99% of radiation at wavelengths from about 240 nm to about 275 nm to pass through said cured coating.

11. A curable composition comprising:
a fluid polysiloxane containing from about 85.0 wt % to about 99.0 wt % of a vinyl functional, substantially linear polydiorganosiloxane and from about 1.0 wt % to about 14 wt % of an organohydrogenpolysiloxane; and
a hydrosilation photocatalyst in an amount of about 0.0003 wt % to about 0.15 wt %, said composition being curable by exposure to ultraviolet radiation to provide a cured coating having substantial transparency to ultraviolet radiation.

12. A coated optical fiber comprising:
an optical fiber; and
a curable coating composition comprising:
an organohydrogenpolysiloxane;
an alkenyl functional polysiloxane; and
an ultraviolet radiation absorbing hydrosilation photocatalyst in an amount of from about 0.0003 wt % to about 0.15 wt % for crosslink formation between said organohydrogenpolysiloxane and said alkenyl functional polysiloxane, said curable coating composition crosslinking under the influence of ultraviolet radiation for providing a cured coating that allows from about 70% to about 99% of radiation of wavelengths from about 240 nm to about 275 nm to pass therethrough.

13. The coated optical fiber of claim 12, wherein said optical fiber is a germanosilicate optical fiber.

14. The coated optical fiber of claim 13, wherein said germanosilicate optical fiber contains a dopant selected from the group consisting of boron, tin and cerium.

15. The coated optical fiber of claim 12, wherein said organohydrogenpolysiloxane is selected from organohydrogenpolysiloxane homopolymers, copolymers and mixtures thereof,

16. The coated optical fiber of claim 12, wherein said alkenyl functional polysiloxane is a substantially linear polydiorganosiloxane having alkenyl groups selected from the group consisting of vinyl groups, allyl groups, butenyl groups, hexenyl groups, octenyl groups, and pentenyl groups and mixtures thereof.

17. The coated optical fiber of claim 12, wherein said hydrosilation catalyst is a complex compound selected from the group consisting of (η⁵-cyclopentadienyl)trialkylplatinum complexes, (η-diolefin)(σ-aryl) platinum complexes, β-diketone platinum complexes and β-diketone palladium complexes.

18. The curable composition of claim 17, wherein said complex compound is selected from the group consisting of bis-acetylacetonate platinum (II) and (η⁵-cyclopentadienyl)trimethyl platinum.

19. An optical fiber refractive index grating comprising:
an optical fiber;
a cured coating of a curable coating composition comprising:
an organohydrogenpolysiloxane;
an alkenyl functional polysiloxane; and
an ultraviolet radiation absorbing hydrosilation photocatalyst in an amount of from about 0.0003 wt % to about 0.15 wt % for crosslink formation between said organohydrogenpolysiloxane and said alkenyl functional polysiloxane, said curable coating composition crosslinking under the influence of ultraviolet radiation for providing said cured coating that allows from about 70% to about 99% of radiation of wavelengths from about 240 nm to about 275 nm to pass therethrough; and
a refractive index grating, formed in said optical fiber by high intensity ultraviolet radiation passing through said cured coating to produce periodic variations of refractive index in said optical fiber to provide said optical fiber refractive index grating.

20. A process for forming an optical fiber refractive index grating, said process comprising the steps of:
providing an optical fiber;
applying a curable coating composition to said optical fiber, said curable coating composition comprising:
an organohydrogenpolysiloxane;
an alkenyl functional polysiloxane; and
an ultraviolet radiation absorbing hydrosilation photocatalyst in an amount of from about 0.0003 wt % to about 0.15 wt % for crosslink formation between said organohydrogenpolysiloxane and said alkenyl functional polysiloxane;
exposing said curable coating composition to ultraviolet radiation for providing a cured coating that allows from about 70% to about 99% of radiation of wavelengths from about 240 nm to about 275 nm to pass therethrough; and
exposing said optical fiber to a pattern of high intensity ultraviolet radiation passing through said cured coating to produce periodic variations of refractive index in said optical fiber to provide said optical fiber refractive index grating.

21. The process of claim 20, further including heating said curable coating composition applied to said optical fiber.

22. A process for continuous production of a coated optical fiber, said process comprising the steps of:
providing a glass preform;
heating said glass preform to a temperature to provide a melted portion of said glass perform;
drawing an optical fiber from said melted portion of said glass perform;
applying a curable coating composition to said optical fiber, said curable coating composition comprising:
an organohydrogenpolysiloxane;
an alkenyl functional polysiloxane; and
an ultraviolet radiation absorbing hydrosilation photocatalyst in an amount of from about 0.0003 wt % to about 0.15 wt % for crosslink formation between said organohydrogenpolysiloxane and said alkenyl functional polysiloxane;
exposing said curable coating composition to ultraviolet radiation for providing said coated optical fiber having a cured coating that allows from about 70% to about 99% of radiation of wavelengths from about 240 nm to about 275 nm to pass therethrough; and
heating said coated optical fiber at temperatures between about 350° C. and about 700° C.

23. The process of claim 22, further including winding said coated optical fiber onto a take-up reel.

24. The process of claim 22, further including exposing said coated optical fiber to a pattern of high intensity ultraviolet radiation passing through said cured coating to produce periodic variations of refractive index in said optical fiber to provide an optical fiber refractive index grating.
